(19) United States
(12) Patent Application Publication
(10) Pub. No.: US 2009/0240450 A1
(43) Pub. Date: Sep. 24, 2009

(54) SYSTEM AND METHOD FOR EVALUATING A TEMPERATURE RISE OF A PRINTED CIRCUIT BOARD TRACE

(75) Inventors: CHIH-WEI TSAI, Tu-Cheng (TW); SHOU-KUO HSU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/351,858

(22) Filed: Jan. 12, 2009

(30) Foreign Application Priority Data
Mar. 21, 2008 (CN) 200810300660.6

(51) Int. Cl. G06F 19/00; G06F 15/00

(52) U.S. Cl. 702/64; 702/130

(57) ABSTRACT

A method for evaluating a temperature rise of a printed circuit board (PCB) trace receives a plurality of attribute parameters of the PCB trace. A temperature rise formula is determined for the PCB trace. The method further calculates the temperature rise by applying the temperature rise formula, and outputs the temperature rise.

### FIELD OF THE INVENTION

Embodiments of the present disclosure relate to a system and method for analyzing printed circuit board (PCB) traces, and more particularly to a system and method for evaluating a temperature rise of a PCB trace.

### DESCRIPTION OF RELATED ART

A printed circuit board (PCB) provides mechanical support and electrical connections between electronic components using traces. A temperature rise of a PCB trace may occur when a current passes through the PCB trace. The temperature rise of the PCB trace is critical because an excessive temperature rise may cause the PCB to become unstable and unreliable. Therefore, it is required for a designer to evaluate the temperature rise of a PCB trace before PCB layout.

### BRIEF DESCRIPTION OF THE DRAWINGS

FIG. 1 is a block diagram of one embodiment of a system for evaluating a temperature rise of a PCB trace.

FIG. 2 is a block diagram of one embodiment of a temperature rise calculator comprising function modules.

FIG. 3 is a flowchart of one embodiment of a method for evaluating a temperature rise of a PCB trace.

FIG. 4 illustrates one embodiment of relationship curves depicting a relationship between a trace current and a trace width.

### DETAILED DESCRIPTION OF CERTAIN INVENTIVE EMBODIMENTS

All of the processes described below may be embodied in, and fully automated via, functional code modules executed by one or more general purpose computers or processors. The code modules may be stored in any type of computer-readable medium or other computer storage device. Some or all of the methods may alternatively be embodied in specialized computer hardware.

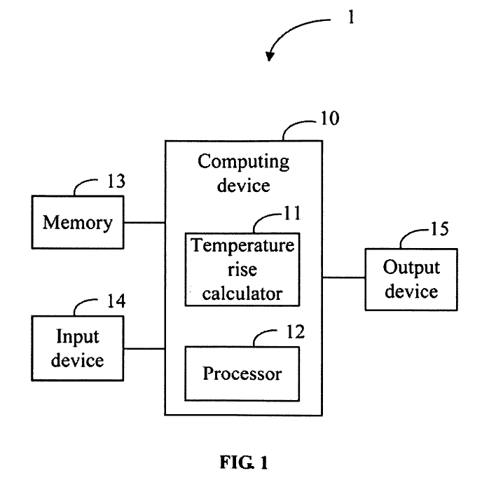

FIG. 1 is a block diagram of one embodiment of a system 1 for evaluating a temperature rise of a printed circuit board (PCB) trace. The system 1 may be used to calculate the temperature rise of the PCB trace quickly and accurately. In one embodiment, the system 1 includes a computing device 10, and a memory 13 connected to the computing device 10. Examples of the computing device 10 include personal computer systems, such as desktop or laptop computers, and personal digital assistants (PDAs). The computing device 10 includes a temperature rise calculator 11. The memory 13 stores program instructions of the temperature rise calculator 11, and stores data that are used, processed, and obtained while the temperature rise of the PCB trace is calculated. The computing device 10 may be further connected to at least one input device 14 and at least one output device 15. The input device 14 may be a keyboard or a mouse. The output device 15 may be a monitor or a printer.

The temperature rise calculator 11 is configured for receiving a plurality of attribute parameters of the PCB trace from the input device 14, and determining a temperature rise formula according to the attribute parameters. The temperature rise calculator 11 is further configured for calculating the temperature rise of the PCB trace by applying the temperature rise formula. In one embodiment, the computing device 10 may comprise one or more processors, such a processor 12, to control the temperature rise calculator 11 to perform corresponding operations for calculating the temperature rise of the PCB trace.

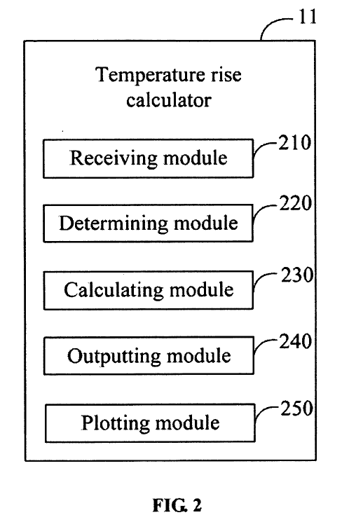

FIG. 2 is a block diagram of one embodiment of the temperature rise calculator 11 comprising function modules. In one embodiment, the temperature rise calculator 11 may include a receiving module 210, a determining module 220, a calculating module 230, an outputting module 240, and a plotting module 250. The processor 12 may be used to execute one or more operations for the receiving module 210, the determining module 220, the calculating module 230, the outputting module 240, and the plotting module 250.

The receiving module 210 is configured for receiving the attribute parameters of the PCB trace. The attribute parameters may include a trace layer, a trace width (W), a trace thickness (Th), and a trace current (I). The trace layer denotes where the PCB trace is located. The trace layer may be an internal layer or an external layer of the PCB. It may be understood that a PCB trace in an internal layer of the PCB may cause a greater temperature rise than another PCB trace in an external layer of the PCB under a same condition. The trace current denotes a current value of the PCB trace. It may be understood that a cross-sectional area (A) of the PCB trace is the product of the trace width and the trace thickness, i.e. A=W×Th. A current density (J) of the PCB trace is the quotient of the trace current and the cross-sectional area, i.e. J=I/A.

The determining module 220 is configured for determining a temperature rise formula to calculate the temperature rise (ΔT) of the PCB trace according to the trace layer. In one embodiment, where the trace current I of the PCB trace is received, the determining module 220 may determine the temperature rise formula as

$$Δ T = {( \frac{I}{0.0647 \times {( W \times Th )}^{0.6732}} )}^{\frac{1}{0.4281}} or Δ T = {( \frac{I}{0.0647 \times {A}^{0.6732}} )}^{\frac{1}{0.4281}}$$

if the trace layer is an external layer, and determine the temperature rise formula as

$$Δ T = {( \frac{I}{0.015 \times {( W \times Th )}^{0.7349}} )}^{\frac{1}{0.5453}} or Δ T = {( \frac{I}{0.015 \times {A}^{0.7349}} )}^{\frac{1}{0.5453}}$$

if the trace layer is an internal layer.

In another embodiment, where the current density J of the PCB trace is received, the determining module 220 may determine the temperature rise formula as

$$Δ T = {( \frac{J}{0.0647 \times {( W \times Th )}^{- 0.3268}} )}^{\frac{1}{0.4281}} or Δ T = {( \frac{J}{0.0647 \times {A}^{- 0.3268}} )}^{\frac{1}{0.4281}}$$

if the trace layer is an external layer, and determine the temperature rise formula as

$$Δ T = {( \frac{J}{0.015 \times {( W \times Th )}^{- 0.2651}} )}^{\frac{1}{0.5453}} or Δ T = {( \frac{J}{0.015 \times {A}^{- 0.2651}} )}^{\frac{1}{0.5453}}$$

if the trace layer is an internal layer.

The calculating module 230 is configured for calculating the temperature rise of the PCB trace by applying the temperature rise formula. In one embodiment, the calculating module 230 is further configured for calculating a resistance (R) and a voltage drop (V) of the PCB trace according to the temperature rise, the trace width, the trace thickness, and the trace current of the PCB trace. In one embodiment, the calculating module 230 calculates the resistance and the voltage drop of the PCB trace by applying formulas

$$R = \frac{TL \times ( 0.6255 + 0.00267 \times ( T + Δ T ) )}{W \times Th} ,$$

and V=I×R, wherein T is an ambient temperature of an environment surrounding the PCB, and TL is a trace length of the trace.

The outputting module 240 is configured for outputting the temperature rise of the PCB trace to the output device 15.

The plotting module 250 is configured for plotting a relationship curve for the temperature rise of the PCB trace. The plotting module 250 may plot the relationship curve to depict a relationship between the trace current and the trace width. In one embodiment, the calculating module 230 may calculate different temperature rises of the PCB trace based on different trace currents and trace widths. Accordingly, the plotting module 250 may plot more than one relationship curve for the different temperature rises of the PCB trace.

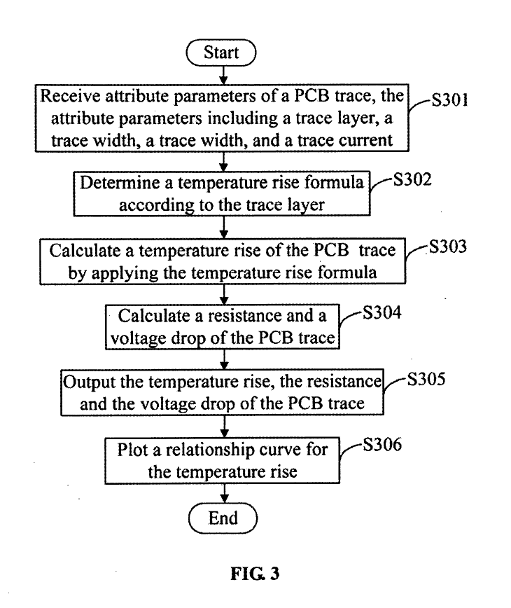

FIG. 3 is a flowchart of one embodiment of a method for evaluating a temperature rise of a PCB trace by implementing the system of FIG. 1. The method may be used to calculate a temperature rise of a PCB trace quickly and accurately. Depending on the embodiments, additional blocks may be added, others removed, and the ordering of the blocks may be changed.

In block 301, the receiving module 210 receives a plurality of attribute parameters of the PCB trace from the input device 14. In one embodiment, the attribute parameters include a trace layer, a trace width (W), a trace thickness (Th), and a trace current (I). In one embodiment, the temperature rise calculator 11 provides a user interface to receive the attribute parameters. For example, four input boxes are used in the user interface to respectively receive the trace layer, the trace width, the trace thickness, and the trace current. The trace layer may be an internal layer or an external layer. A cross-sectional area (A) of the PCB trace is the product of the trace width and the trace thickness, i.e. A=W×Th. A current density (J) of the PCB trace is the quotient of the trace current and the cross-sectional area, i.e. J=I/A.

In block 302, the determining module 220 determines a temperature rise formula to calculate a temperature rise (ΔT) of the PCB trace according to the trace layer. In one example, the trace layer is an internal layer. Accordingly, the determining module 220 determines the temperature rise formula as

$$Δ T = {( \frac{I}{0.0647 \times {( W \times Th )}^{0.6732}} )}^{\frac{1}{0.4281}} .$$

In another example, the trace layer is an external layer. Accordingly, the determining module 220 determines the temperature rise formula as

$$Δ T = {( \frac{I}{0.015 \times {( W \times Th )}^{0.7349}} )}^{\frac{1}{0.5453}} .$$

In block 303, the calculating module 230 calculates the temperature rise of the PCB trace by applying the temperature rise formula. For example, the calculating module 230 calculates the temperature rise by applying the temperature rise formula

$$Δ T = {( \frac{I}{0.0647 \times {( W \times Th )}^{0.6732}} )}^{\frac{1}{0.4281}}$$

when the trace layer is an internal layer.

In block 304, the calculating module 230 calculates a resistance (R) and a voltage drop (V) of the PCB trace according to the temperature rise of the PCB trace, the trace width, the trace thickness, and the trace current. In one embodiment, the calculating module 230 calculates the resistance and the voltage drop of the PCB trace by applying formulas

$$R = \frac{TL \times ( 0.6255 + 0.00267 \times ( T + Δ T ) )}{W \times Th} ,$$

and V=I×R, wherein T is an ambient temperature, and TL is a trace length.

In block 305, the outputting module 240 outputs the temperature rise, the resistance, and the voltage drop of the PCB trace to the output device 15, such as a monitor. In one embodiment, the outputting module 240 outputs the temperature rise, the resistance, and the voltage drop of the PCB trace via the user interface.

In block 306, the plotting module 250 plots a relationship curve for the temperature rise of the PCB trace. The plotting module 250 may plot a relationship curve to depict a relationship between the trace current and the trace width.

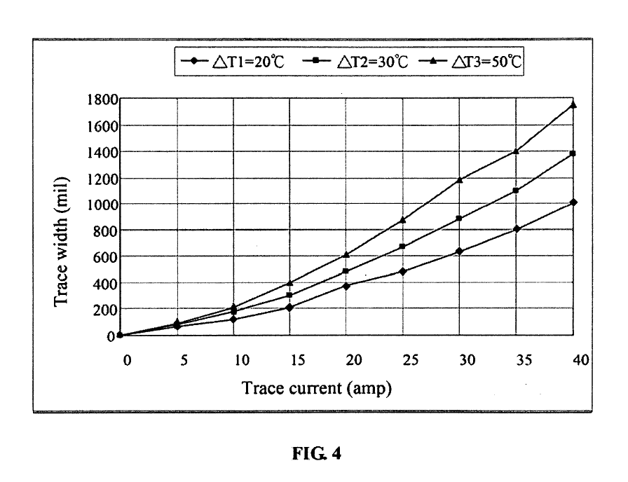

In one embodiment, the calculating module 230 may calculate different temperature rises of the PCB trace based on different trace currents and trace widths. Accordingly, the plotting module 250 may plot more than one relationship curve for the different temperature rises of the PCB trace. In another embodiment, the plotting module 250 may plot several relationship curves depicting a relationship between the trace current and the trace width for several given temperature rises of the PCB trace. In an example, with reference to FIG. 4, the plotting module 250 respectively plots three relationship curves for 20° C., 30° C., and 50° C. temperature rises of the PCB trace.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing system for evaluating a temperature rise of a printed circuit board (PCB) trace, the computing system comprising:
a receiving module configured for receiving a plurality of attribute parameters of the PCB trace from an input device, the attribute parameters of the PCB trace comprising a trace layer of the PCB trace;
a determining module configured for determining a temperature rise formula according to the trace layer;
a calculating module configured for calculating the temperature rise of the PCB trace by applying the temperature rise formula;
an outputting module configured for outputting the temperature rise of the PCB trace to an output device; and
at least one processor that executes the receiving module, the determining module, the calculating module, and the outputting module.

2. The system of claim 1, wherein the attribute parameters of the PCB trace further comprise a trace width, a trace thickness, and a trace current of the PCB trace.

3. The system of claim 2, wherein the calculating module is further configured for calculating a resistance and a voltage drop of the PCB trace according to the temperature rise, the trace width, the trace thickness, and the trace current of the PCB trace.

4. The system of claim 2, further comprising a plotting module configured for plotting a relationship curve for the temperature rise of the PCB trace, the relationship curve depicting a relationship between the trace current and the trace width of the PCB trace.

5. The system of claim 2, wherein the temperature rise formula is determined as
$$Δ T = {( \frac{I}{0.0647 \times {( W \times Th )}^{0.6732}} )}^{\frac{1}{0.4281}}$$
if the trace layer is an external layer of the PCB, wherein ΔT is the temperature rise, I is the trace current, W is the trace width, and Th is the trace thickness.

6. The system of claim 2, wherein the temperature rise formula is determined as
$$Δ T = {( \frac{I}{0.015 \times {( W \times Th )}^{0.7349}} )}^{\frac{1}{0.5453}}$$
if the trace layer is the internal layer of the PCB, wherein ΔT is the temperature rise, I is the trace current, W is the trace width, and Th is the trace thickness.

7. A computer-implemented method for evaluating a temperature rise of a printed circuit board (PCB) trace, the method comprising:
receiving a plurality of attribute parameters of the PCB trace from an input device, the attribute parameters of the PCB trace comprising a trace layer of the PCB trace;
determining a temperature rise formula according to the trace layer;
calculating the temperature rise of the PCB trace by applying the temperature rise formula; and
outputting the temperature rise of the PCB trace to an output device.

8. The method of claim 7, wherein the attribute parameters of the PCB trace further comprise a trace width, a trace thickness, and a trace current of the PCB trace.

9. The method of claim 8, further comprising:
calculating a resistance and a voltage drop of the PCB trace according to the temperature rise, the trace width, the trace thickness, and the trace current of the PCB trace.

10. The method of claim 8, further comprising:
plotting a relationship curve for the temperature rise of the PCB trace, the relationship curve depicting a relationship between the trace current and the trace width of the PCB trace.

11. The method of claim 8, wherein the temperature rise formula is determined as
$$Δ T = {( \frac{I}{0.0647 \times {( W \times Th )}^{0.6732}} )}^{\frac{1}{0.4281}}$$
if the trace layer is an external layer of the PCB, wherein ΔT is the temperature rise, I is the trace current, W is the trace width, and Th is the trace thickness.

12. The method of claim 8, wherein the temperature rise formula is determined as
$$Δ T = {( \frac{I}{0.015 \times {( W \times Th )}^{0.7349}} )}^{\frac{1}{0.5453}}$$
if the trace layer is an internal layer of the PCB, wherein ΔT is the temperature rise, I is the trace current, W is the trace width, and Th is the trace thickness.

13. A computer-readable medium having stored thereon instructions that, when executed by a computerized device, causes the computerized device to:
receive a plurality of attribute parameters of a printed circuit board (PCB) trace from an input device, the attribute parameters of the PCB trace comprising a trace layer of the PCB trace;
determine a temperature rise formula according to the trace layer;
calculate the temperature rise of the PCB trace by applying the temperature rise formula; and
output the temperature rise of the PCB trace to an output device.

14. The medium of claim 13, wherein the user determined parameters of the PCB trace further comprise a trace width, a trace thickness, and a trace current of the PCB trace.

15. The medium of claim 14, further causes the computerized device to:
calculate a resistance and a voltage drop of the PCB trace according to the temperature rise, the trace width, the trace thickness, and the trace current of the PCB trace.

16. The medium of claim 14, further causes the computerized device to:
plot a relationship curve for the temperature rise of the PCB trace, the relationship curve depicting a relationship between the trace current and the trace width of the PCB trace.

17. The medium of claim 14, wherein the temperature rise formula is determined as
$$Δ T = {( \frac{I}{0.0647 \times {( W \times Th )}^{0.6732}} )}^{\frac{1}{0.4281}}$$
if the trace layer is an external layer of the PCB, wherein ΔT is the temperature rise, I is the trace current, W is the trace width, and Th is the trace thickness.

18. The medium of claim 14, wherein the temperature rise formula is determined as
$$Δ T = {( \frac{I}{0.015 \times {( W \times Th )}^{0.7349}} )}^{\frac{1}{0.5453}}$$
if the trace layer is an internal layer of the PCB, wherein ΔT is the temperature rise, I is the trace current, W is the trace width, and Th is the trace thickness.
